(19) United States
(12) Patent Application Publication
(10) Pub. No.: US 2008/0235524 A1
(43) Pub. Date: Sep. 25, 2008

(54) System for peripheral re-enumeration

(76) Inventors: Yugal K. Sharma, Washington, DC (US); Tad Richman, Washington, DC (US); Kurt Beyer, Mill Valley, CA (US)

Correspondence Address: Nields & Lemack, 176 E. Main Street, Suite #5, Westboro, MA, 01581, US

(21) Appl. No.: 12/075,809

(22) Filed: Mar. 14, 2008

Related U.S. Application Data
(60) Provisional application No. 60/918,546, filed on Mar. 16, 2007.

(51) Int. Cl. G06F 1/00

(52) U.S. Cl. 713/300

(57) ABSTRACT

The present invention reduces the need for peripherals to be physically removed and re-installed when a malfunction occurs. In one embodiment, a device is placed in series between the system and the peripheral. This device controls the passage of power to the peripheral. When the peripheral malfunctions, the device disallows passage of power to the peripheral, and at some later point restores power, effectively emulating a physical removal and re-installation. In a second embodiment, additional software is added to the software driver for the peripheral. In this scenario, the additional software, upon detecting that the peripheral is incommunicative, would remove power being supplied to the peripheral by the system. Again, at some later point, power is restored, thereby emulating a disconnect/reconnect sequence.

This application claims priority of U.S. Provisional application Ser. No. 60/918,546 filed Mar. 16, 2007, the disclosure of which is incorporated herein by reference.

### BACKGROUND OF THE INVENTION

A multitude of new standards and peripherals purportedly adhering to these standards has been made available in the past several years. New computer standards, such as USB, Firewire(IEEE1394), multi-media card (MMC), have been and continue to be proliferated in the market. Associated with each are many peripherals claiming to be compatible with the standard. While these standards and peripherals offer the consumer many benefits, such as increased compatibility, price competition between peripheral vendors, and increased peripheral supply, there are drawbacks as well. The most obvious of these drawbacks is the robustness of the peripheral in terms of actual compatibility to the standard. Another is the reliability of the peripheral in question.

For example, a consumer, wishing a USB storage device, can enter a retail store and find a number of different options, often offering a wide range of features, storage capacity and at a varying prices. Each professes to be compatible with the latest standard, such as USB 2.0. Typically, there are peripherals from several different vendors. Because of the interoperability of USB, the consumer is not concerned whether the particular peripheral will work in his system and therefore the purchase is typically made based on factors such as price and storage capacity.

However, once the USB peripheral is placed in the system, the user may discover that, while the peripheral functions properly most of the time, there are instances where the peripheral “hangs” or “freezes”. This is a state in which the computer is not longer able (or willing) to communicate with the peripheral. In other words, the software driver of the computer system is unable to properly communicate with the installed USB peripheral. Oftentimes, the reason for the failure is intermittent and difficult to diagnose. The source of the problem can range from bad media(e.g. optical disks, defective hard drive platters, faulty FLASH ROM, etc) to errors in either the peripheral hardware silicone or the software code. Determining the exact cause of these problems becomes both time and cost prohibitive in applications where the performance of the given peripheral at that exact point in time is not mission-critical. In addition, the variation of internal components and software and firmware revisions that occurs in peripherals bearing the same manufacturer name and model number greatly increases the complexity of troubleshooting these issues.

As mentioned above, the results of a malfunctioning peripheral is the placement of the peripheral by the system into an “offline” or “error” state. At this point, the peripheral no longer responds to normal commands. Typically, the software driver on the system ceases to communicate with the faulty peripheral. In order to regain functionality, the peripheral typically must be physically disconnected and reconnected to the host. In some cases, the power to the peripheral may need to be cycled to regain functionality.

While this is a mild inconvenience to the user who is physical present at their system, such a solution is unacceptable in an automated environment, where multiple systems, each having multiple peripherals are used with minimal or no human interaction. Considerable time and money can be lost if a non-critical peripheral “freezes” during an automated process, effectively shutting down the system until a person can physical remove and re-install the peripheral.

Clearly a system and method by which human intervention is not required to perform this action would be beneficial, especially in automated environments.

### SUMMARY OF THE INVENTION

The problems of the prior art have been addressed by the present invention, which reduces the need for peripherals to be physically removed and re-installed when a malfunction occurs. In one embodiment, a device is placed in series between the system and the peripheral. This device controls the passage of power to the peripheral. When the peripheral malfunctions, the device disables the power passage to the peripheral, and at some later point restores the power passage, effectively emulating a physical removal and re-installation. In a second embodiment, additional software is added to the software driver for the peripheral. In this scenario, the additional software, upon detecting that the peripheral is incommunicative, would remove power being supplied to the peripheral by the system. Again, at some later point, power is restored, thereby emulating a disconnect/reconnect sequence.

### BRIEF DESCRIPTION OF THE DRAWINGS

FIG. 1 illustrates the pinout of a standard USB connector;

FIG. 2 illustrates the pinout of a standard 6-pin Firewire (IEEE1394) connector;

FIG. 3 represents a block diagram showing one embodiment of the present invention; and

FIG. 4 represents a block diagram showing a second embodiment of the present invention

### DETAILED DESCRIPTION OF THE INVENTION

Physical disconnect/reconnect sequences are common when a peripheral malfunctions or “freezes”. This action works for several reasons. First, by disconnecting the peripheral, the system deletes that peripheral from the list of enumerated devices and therefore deletes the previous state of the peripheral. Second, the peripheral is removed from its power supply, which causes it to reset. Therefore, when the same peripheral is then reinstalled, the system re-enumerates it and the peripheral is no longer in its non-functional state.

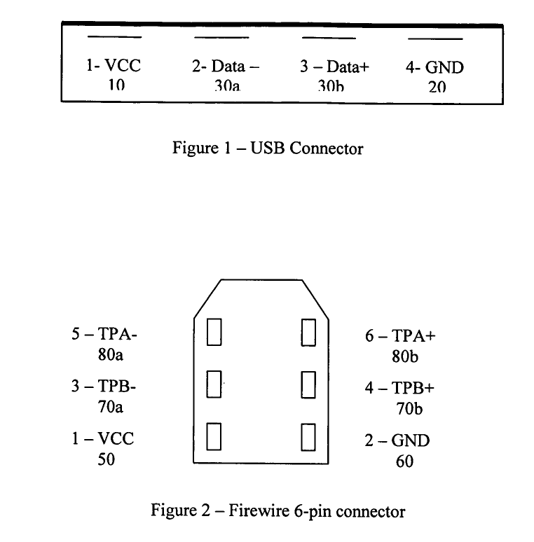

Most peripherals for use with computer systems do not have an independent power source. Rather, they rely on power being supplied by the host system to which they are attached. This power usually comes through a connector. FIG. 1 illustrates the industry standard pinout of a USB connector, while FIG. 2 illustrates the pinout of a standard 6-pin Firewire connector. Note that in both connectors, the system supplies both power and ground to the device, as well as data signals for communication. While only 2 industry standard connectors are shown, the present invention is not so limited. The present invention is equally applicable to any standard or peripheral which receives its power from the host computer system. The present invention can also be used in one embodiment in those cases where the peripheral has an independent power source.

Returning to FIG. 1, it can be seen that USB requires a single power line 10, a single ground line 20 and two data lines 30a, 30b. Similarly, as seen in FIG. 2, Firewire requires a single power line 50, a single ground line 60, and a set of data signals 70a,70b and a set of strobe signals 80a,80b. Thus, in the case of both these standards and many others, the power for the peripheral is supplied by the host computer system. Standards such as these allow for two different embodiments of the present invention; both of which will be described in more detail below. Other standards in which the peripheral has an independent power source, which is not supplied through the connector, can still be used with the present invention, but using only one of the previously mentioned embodiments.

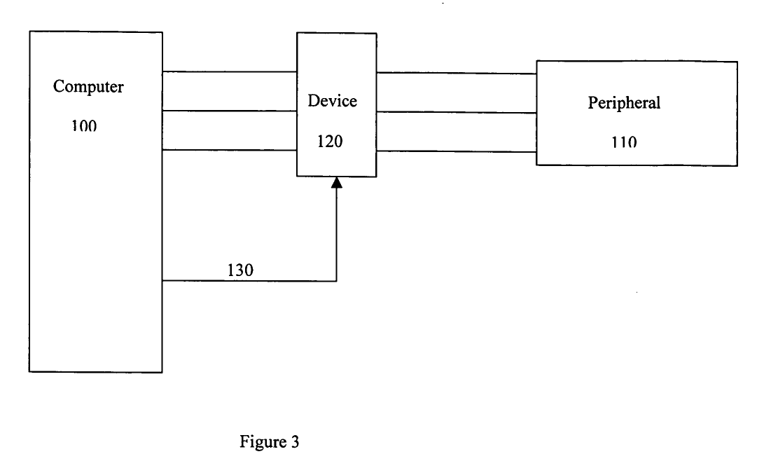

FIG. 3 shows a first embodiment of the present invention, which is suitable for use with standards and peripherals that receive power from the computer system. A host computer 100 is adapted to communicate with one or more peripherals 110. As described above, a connector between the computer and the peripheral is used to transmit data signals, ground, and typically power. In one embodiment, a device 120 is interposed between the computer system 100 and the peripheral 110, such that the signals all pass through the device 120. In this way, the device 120 has the ability to establish and destroy connections between the computer 100 and the peripheral 110. In one embodiment, the data signals from the computer 100 are simply passed unaltered through the device 120, and only the power signal is switched by the device 120. In a second embodiment, the data signals are also switched by the device 120, such as by using FETs, cross bar switches, or other similar components. In this way, the peripheral is completely isolated from the computer, thereby emulating a physical removal. In another embodiment, the data signals are routed directly between the computer 100 and the peripheral 110 and do not pass through the device 110.

The device 120 has two modes of operation; transparent and isolation. In transparent mode, it simply passes all signals between the computer and the peripheral. In isolation mode, the device disrupts the communication path of the power signal, and optionally the data signals. The mode of operation of the device is determined by input signal 130. This input signal is generated by the computer 100 and is passed to the device 120 via an external connector. Suitable methods include use of the RS232 serial port, parallel port, a USB port, or other external interface. In one embodiment, the computer communicates via the input signal to the device to switch to isolation mode. At a later time, the computer communicates via the input signal to the device to switch back to transparent mode. In a second embodiment, the computer communicates via the input signal to the computer to switch to isolation mode. The device reverts back to transparent mode after a predetermined time period. Following this action, the computer will automatically re-enumerate the peripheral, since it appears to the computer to have been newly installed.

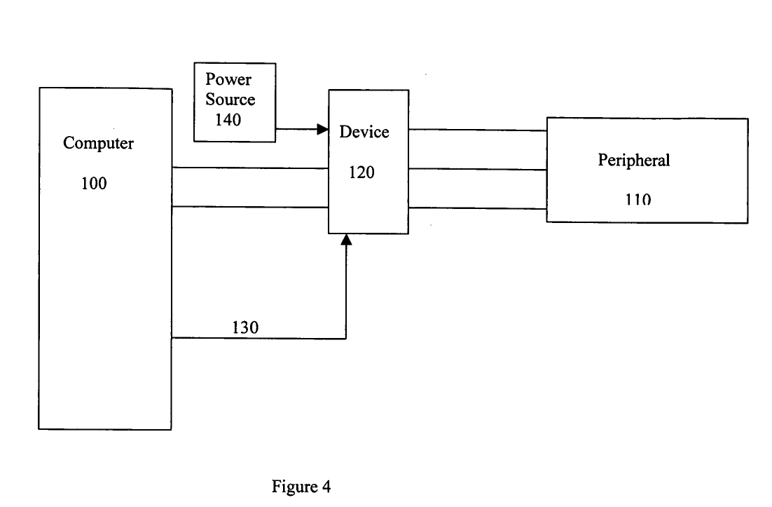

FIG. 4 shows a variation of the above embodiment, in which the peripheral 110 is powered via an independent power source and not by the computer system 100. In this scenario, the device 120 works exactly as described above, however the source of the peripheral's power is not via the computer 100, but rather through a separately attached input 140. The operation of the input signal 130 is as described above.

As stated above, the computer controls the input signal 130 to the device. Once the computer detects that the peripheral has malfunctioned and is no longer responsive, it communicates with the device 120. In one embodiment, the software simply starts a timer whenever communication with the peripheral is initiated. If the timer reaches its terminal value, the software will assume that the peripheral is no longer responsive. This terminal value is implementation specific and is based on system and peripheral performance.

In an alternate embodiment, the above functionality is accomplished completely within the computer. This embodiment is only applicable to those peripherals that receive their power from the computer. Since the computer is supplying the power to the peripheral, the above embodiments can be accomplished by having the computer cease supplying peripheral power via the connector. In many systems, the power that is transmitted to the peripheral via the connector is switched by the system such that power is not always present. For example, some operating systems allow the user to enable the USB Root Hub driver to turn off power to the USB port to save power. Thus, the driver has the ability to control the power to the USB Port. In such a system, the equivalent functionality of the device 120 can be accomplished simply by having the device driver, or some other software, disable the power to the peripheral for a brief period of time and then reestablish it. In this case, software, such as that described earlier, is used to detect when the USB peripheral has become non-responsive. When this happens, this software can either directly disable, or direct the device driver to disable the power to the USB port. This action has the same effect as physically disconnecting and reconnecting the peripheral, as described earlier.

What is claimed is:

1. A system for resetting a peripheral connected to a computing device, whereby the interface between said peripheral and said computing device comprises a power signal and a ground signal, said system comprising:
a. An output signal, generated by said computing device, which is asserted when said computing device determines that said peripheral is no longer responsive, and
b. A device interposed between said peripheral and said computing element, such that said power and ground signals may pass through said device to said peripheral, responsive to said output signal such that the assertion of said output signal causes said device to disallow passage of said power signal to said peripheral.

2. The system of claim 1, wherein said device disallows passage of said ground signal when said output signal is asserted.

3. The system of claim 1, wherein said interface further comprises data signals, and said data signals may pass through said device to said peripheral.

4. The system of claim 3, wherein said device disallows the passage of said data signals when said output signal is asserted.

5. The system of claim 1, wherein said device disallows passage of said power signal for a predetermined duration when said output signal is asserted.

6. The system of claim 1, wherein said device disallows passage of said ground signal for a predetermined duration when said output signal is asserted.

7. The system of claim 3, wherein said device disallows passage of said data signals for a predetermined duration when said output signal is asserted.

8. The system of claim 1, wherein said peripheral comprises a USB peripheral.

9. A system for resetting a peripheral connected to a computing device, whereby the interface between said peripheral and said computing device comprises a power signal and a ground signal, said system comprising:
a. A first set of software instructions adapted to determine when said computing device determines that said peripheral is no longer responsive, and generate an indication thereof and
b. A second set of software instructions, responsive to said indication, adapted to disable said power signal to said peripheral when said indication is received.

10. A system for resetting a peripheral connected to a computing device, wherein said peripheral receives power and ground signals via an independent power source through a power input, said system comprising:
a. An output signal, generated by said computing device, which is asserted when said computing device determines that said peripheral is no longer responsive, and
b. A device interposed between said peripheral and said independent power source, such that said power signal may pass through said device to said peripheral, responsive to said output signal such that the assertion of said output signal causes said device to disallow passage of said power signal to said peripheral.

11. The system of claim 10, wherein said device disallows passage of said ground signal when said output signal is asserted.

12. The system of claim 10, wherein said device disallows passage of said power signal for a predetermined duration when said output signal is asserted.

13. The system of claim 10, wherein said device disallows passage of said ground signal for a predetermined duration when said output signal is asserted.

14. The system of claim 10, wherein said peripheral comprises a USB peripheral.
